(19) United States
(12) Patent Application Publication
(10) Pub. No.: US 2013/0043183 A1
(43) Pub. Date: Feb. 21, 2013

(54) Electron Source Modification Of Microporous Halocarbon Filter Membranes

(71) Applicants: Jijun Ge, Boxborough, MA (US); Wai Ming Choi, West Newton, MA (US)

(72) Inventors: Jijun Ge, Boxborough, MA (US); Wai Ming Choi, West Newton, MA (US)

(21) Appl. No.: 13/695,561

(22) PCT Filed: Apr. 26, 2011
(86) PCT No.: PCT/US11/33858

§ 371 Date: Oct. 31, 2012

Related U.S. Application Data
(60) Provisional application No. 61/332,070, filed on May 6, 2010.

(51) Int. Cl. B01D 67/00; B01D 61/14; B01D 69/12; B01D 69/02; B01J 19/12; B01D 71/02

(52) U.S. Cl. 210/490; 204/157.4; 204/157.44; 210/500.21

(57) ABSTRACT

Versions of the invention include electron beam treated microporous halocarbon membranes, particularly fluoro-carbon membranes, and methods for treating one or more surfaces of a polymeric porous halocarbon membrane with electron beams. The modified porous membrane is stable, resists dewetting, and retains its mechanical properties and chemical inertness.

### RELATED APPLICATIONS

This application claims the benefit of U.S. Provisional Application No. 61/332,070, filed on May 6, 2010. The entire teachings of the above application are incorporated herein by reference.

### BACKGROUND OF THE INVENTION

Filtration can be used in the pharmaceutical, microelectronics, chemical and food industries to provide product and process purity. In these applications, porous membranes can remove particulate, ionic, and other contaminants from fluids. These porous membranes, whose pore size can range from the ultrafiltration (approximately 0.001 μm) to microfiltration (approximately 10 μm), can be made from a chemically compatible and mechanically stable polymeric matrix and have measurable retention, pore size or pore size distribution, and thickness. The size of pores in microporous membranes can range on the order of from about 0.01 to about 50 microns, and can be chosen depending upon the particle size or type of impurity to be removed, pressure drop requirements, and viscosity requirements of the application. In use, the porous membranes are generally incorporated into a device which is adapted to be inserted within a fluid stream to effect removal of particles, microorganisms or a solute from process fluids.

Fluid filtration or purification is usually carried out by passing the process fluid through the membrane filter under a differential pressure across the membrane which creates a zone of higher pressure on the upstream side of the membrane than on the downstream side. Liquids being filtered experience a pressure drop across the porous membrane and the membrane is subject to a mechanical stress. This pressure differential can also result in the precipitation of dissolved gases from the liquid; the liquid on the upstream side of the porous membrane has a higher concentration of dissolved gases than the liquid on the downstream side of the porous membrane. This occurs because gases, such as air, have greater solubility in liquids at higher pressures than in liquids at lower pressures. As the liquid passes from the upstream side of the porous membrane to the downstream side, dissolved gases can come out of solution and form bubbles in the liquid and or on porous membrane surfaces. This precipitation of gas is commonly referred to as outgassing of the liquid. Outgassing of a liquid can also occur spontaneously without a pressure differential as long as the liquid contains dissolved gases and there is a driving force for the gases to come out of solution, such as nucleating sites, a change in temperature, or a change in chemical composition that results in the formation of bubbles or gas pockets on the surfaces of a porous membrane. Outgassing liquids typically used in the manufacture of pharmaceuticals, semiconductor devices, and displays can include very high purity water, ozonated water, peroxide containing liquids, organic solvents such as alcohol, and other chemically active liquids, such as concentrated aqueous acids or bases which can contain an oxidizer.

Membrane filtration of chemically active liquids benefits from the use of a chemically inert filter to prevent membrane degradation and loss of integrity which can result in extractable material being released from the filter during use. Membrane filters made from halogenated polyolefins, for example fluorine containing polymers like polytetrafluoroethylene, are commonly utilized in these applications. Fluorine-containing polymers are well known for their chemical inertness and excellent resistance to chemical attack. Fluorine containing polymer membranes have low surface energy and are hydrophobic, and therefore membranes made from such polymers are difficult to wet with aqueous liquids or other liquids, which have significantly greater surface tension than the surface energy of the membrane. During the filtration of outgassing liquids with a hydrophobic porous membrane, the porous membrane can provide nucleating sites for dissolved gases to come out of solution under the driving force of the pressure differential during the filtration process. Gases which come out of solution at these nucleating sites on the hydrophobic membrane surfaces, including the interior pore surfaces and the exterior or geometric surfaces, can form gas pockets which adhere to the membrane. As these gas pockets grow in size due to continued outgassing, they may begin to displace liquid from the pores of the membrane which can reduce the effective filtration area of the membrane. This phenomenon is usually referred to as dewetting of the porous membrane since the liquid-wetted, or liquid-filled portions of the porous membrane are gradually converted into gas-filled portions.

Dewetting of a porous membrane can also occur spontaneously when a wet membrane, such as a hydrophobic membrane wet with an aqueous fluid, is exposed to a gas such as air. It has been found that this dewetting phenomenon occurs more frequently and is more pronounced in halocarbon-based membranes, and in particular in fluorocarbon-based membranes. It has also been found that the rate at which dewetting occurs is greater in small pore size membranes such as 0.2 microns or less, than in larger pore size membranes.

Thus, as the membrane filter dewets with time, it becomes more difficult to purify or filter the same volume of process liquid per unit time as when the filter was newly installed and therefore completely wet. Installation of a new filter, re-wetting the dewet filter, or changes in the process to compensate for the reduced liquid flow translate into higher operating costs for the user. Re-wetting is time consuming, often utilizes flammable or other hazardous liquids that must be disposed of, and requires flushing, which takes time.

Thus there exists a need for a wettable membrane that resists dewetting upon exposure to air and that resists outgassing during processing of liquids. There is a need for membranes with these improved properties that still retain the desired properties of chemical inertness and mechanical strength.

### SUMMARY OF THE INVENTION

Versions of the invention include methods of treating a halocarbon membrane, particularly a fluorocarbon membrane, to modify the contact wettability of one or more surfaces thereof. The method includes the steps of contacting the membrane with a chemical solution while exposing the membrane to an electron source for a period of time sufficient to modify the contact wettability of one or more surfaces of the membrane. The membrane retains its chemical inertness, and the flow time does not increase by more than about 30%. The method can include additional steps, such as prewetting the membrane with a low surface tension fluid prior to electron beam treatment. The method can also include contacting the treated membrane with an acid after the membrane has been exposed to the electron beam source. The method can also include rinsing the membrane after the membrane has been exposed to the electron beam source. The method can also include drying the membrane after the membrane has been exposed to the electron beam source.

Versions of the invention include an electron source surface modified halocarbon membrane. The modified membrane can have a halogen-to-carbon mole ratio that is about 5% lower than the untreated membrane, and in some instances can have a fluorine-to-carbon mole ratio that is about 5% lower than the untreated membrane. In some instances, the modified membrane can have a sulfur-to-carbon mole ratio that ranges from about 0 to about 0.01. In some instances, the modified membrane can have a sulfur-to-carbon mole ratio that ranges from about 0 to about 0.006. The modified membrane has essentially the same porosity as the untreated membrane. The modified membrane is non-dewetting. The flow time of the electron source surface modified membrane does not increase by more than about 30% compared to the untreated membrane.

The membranes and methods of making them of the present invention have improved properties. For example, the membranes are more hydrophilic and have improved contact wettability and resistance to dewetting. The treated membranes have a pressure drop, sieving particle retention characteristics, membrane strength, pore size, mean bubble point, or any combination of these that is similar to the untreated membrane.

### DETAILED DESCRIPTION OF THE INVENTION

While this invention has been particularly shown and described with references to example embodiments thereof, it will be understood by those skilled in the art that various changes in form and details may be made therein without departing from the scope of the invention encompassed by the appended claims.

Before the present compositions and methods are described, it is to be understood that this invention is not limited to the particular molecules, compositions, methodologies or protocols described, as these may vary. It is also to be understood that the terminology used in the description is for the purpose of describing the particular version or versions only, and is not intended to limit the scope of the present invention which will be limited only by the appended claims.

It must also be noted that as used herein and in the appended claims, the singular forms “a”, “an”, and “the” include plural reference unless the context clearly dictates otherwise. Thus, for example, reference to a “pore” is a reference to one or more pores and equivalents thereof known to those skilled in the art, and so forth. Unless defined otherwise, all technical and scientific terms used herein have the same meanings as commonly understood by one of ordinary skill in the art. Although any methods and materials similar or equivalent to those described herein can be used in the practice or testing of versions of the present invention, the non-limiting examples of methods, devices, and materials are now described. All publications mentioned herein are incorporated by reference in their entirety. Nothing herein is to be construed as an admission that the invention is not entitled to antedate such disclosure by virtue of prior invention.

### Electron Beam or Electron Source Modification

A surface that has been modified or altered using an electron source is referred to herein as an “electron beam modified” surface or membrane or an “electron source modified” surface or membrane. Both are contemplated by the invention herein. A “modified” or “altered” surface as used herein is intended to include any changes in the surface or membrane after treatment compared to its untreated counterpart. Specific modifications and testing methods used to ascertain modification will be discussed in detail herein.

In some versions of the invention described herein, the electron source is an electron beam. In versions of the method described below, the electron beam can be operated at a voltage between about 50 kV and about 175 kV. More preferably, the electron beam can be operated at a voltage between about 140 kV and about 175 kV. In versions of the invention described herein, the membrane can be exposed to an electron beam radiation dosage between about 1 MRad and about 10 MRad. More preferably, the membrane can be exposed to an electron beam radiation dosage between about 3 MRad and about 8 MRad. The radiation dosage can be adjusted by altering the line speed, commonly measured in feet per minute (FPM), of the membrane as it travels past the electron beam.

### Membranes

Porous membrane substrates can include porous or microporous halogenated polyolefins such as polyvinylchloride, polyvinylidenefluoride, polytetrafluoroethylene (PTFE) or a modified polytetrafluoroethylene, fluorinated ethylene-propylene copolymer (FEP), ethylene-tetrafluoroethylene copolymer or a perfluoroalkoxy polymer (PFA), and the like. More preferably, the halogenated membrane substrate is a fluorinated membrane. More preferably, the halogenated membrane substrate is polytetrafluoroethylene (PTFE). Halocarbon membranes, in particular fluorocarbon membranes, and more particularly PTFE, are desirable membranes for use in filtration application because they are relatively chemically inert. A chemically inert membrane is one that can withstand harsh chemical environments, such as acidic environments, basic environments, oxidizing environments, reducing environments, high temperatures, organic solvents, and other harsh environments or any combination thereof without substantial change to the chemical composition of the membrane or to its pore size or mechanical properties. In some versions the fluorine-containing polymers can be modified PTFE resins containing at least 98 percent tetrafluoroethylene with modifiers such as but not limited to hexafluoropropylene, perfluoro(alkyl vinyl ether), or mixtures of these or others. The porous membrane can be free of an externally applied coating of monomers prior to electron beam treatment, or the porous membrane can be previously coated with monomers. In some versions of the invention the porous polymer is PTFE or expanded PTFE. The porous membrane can be a microporous or ultrafiltration membrane. A microporous membrane can have an average pore size ranging on the order of from about 0.01 microns to about 50 microns, and can be chosen depending upon the particle size or type of impurity to be removed, pressure drop requirements, and viscosity requirements of the application. An ultrafiltration membrane can have an average pore size ranging from 0.001 microns to about 0.01 microns.

The porous membrane modified by the electron beam treatment can include coating free cast, extruded, or laminated membranes used to filter liquids. The porous membrane can comprise a single porous layer, a layer having a pore size gradient, or multilayer (extruded or laminated membranes with one or more layers having different pore sizes for example) made from thermoplastics such as halogenated polyolefins like polytetrafluoroethylene, modified polytetrafluorethylenes, perfluoro (vinyl alkyl ether), FEP, unsaturated polyester (UPE), or other membrane materials. The porous membrane can include a variety of morphologies such as lacy, string and node, open cellular, nodular or other membrane morphologies. The membrane can have a symmetric or asymmetric pore structure. In some versions the crystallinity of the thermoplastic for the membrane is greater than about 65%, in some versions greater than about 75%, and in still other versions greater than about 85%. Without wishing to be bound by theory, the higher the crystallinity of the membrane the more durable the lyophilic surface modification.

The membrane substrate can have any convenient geometric configuration that can be electron beam treated to form hydrophilic surfaces on portions of the membrane including a flat sheet, a corrugated sheet, a hollow fiber or the like. The membrane can be supported or unsupported, isotropic or anisotropic, skinned or unskinned or can be a composite membrane. The membrane substrate can have a thickness between about 5 microns and about 250 microns, preferably between about 10 microns and about 200 microns, and more preferably between about 10 microns and about 30 microns.

The porous polymeric membrane treated by the electron beam can be a single layer membrane having pore sizes or a distribution of pore size that provide sieving particle retention. In some versions the treated porous membrane comprises a plurality of layers which have pores that have the same size in the various layers or in still other versions the porous membrane can comprises a plurality of layers which have pores that have different sizes in the various layers. In some versions the porous membrane can include a filtration layer supported by one or more support layers or layers of different porosity. The layers can provide support for an inner filtration layer, for example large pore size support layers on either side of a tight, smaller pore filtration layer. The layer may be a skinned membrane, may be a membrane without a discernable layer structure, or it may include a gradient of pores or a distribution of pore sizes. In some versions, the porous membrane can be a microporous membrane.

The electron beam treatment method can be used to treat a porous membrane surface selected from nodes, fibrils, pore interiors, portions of the pores, outer surfaces of the membrane, and any combinations of these to make them more hydrophilic than the untreated porous membrane surfaces.

### Functional Modifications to the Membrane

The one or more porous membrane surfaces modified by treatment with an electron beam form a treated membrane that has a pressure drop, characteristic sieving particle retention, membrane strength, membrane thickness, or any combination of these that is within about ±25% of the untreated membrane; in some versions within about ±15% of the untreated membrane; and in still other versions within ±10% or less of the untreated membrane. The membrane can be those ultrafiltration or microfiltration membranes described above.

Membrane Contact Wettability with Methanol

Contact wettability refers to the ability of a sample of a test liquid applied to a portion of a porous membrane to fill the pores of the membrane with the test liquid throughout the thickness of the membrane. The wet portions of the membrane appear transparent compared to un-wet portions of the membrane. Contact wettability also refers to the ability of a sample of a test liquid applied to a portion of a porous membrane to immediately, or within about 1 second to about 2 seconds, fill the pores of the membrane throughout its thickness with the test liquid such that the membrane appears transparent relative to the opaque appearance of portions of the membrane un-wet by the applied liquid. The wet portion of the porous membrane permits a flow of the liquid through the membrane. In contrast, the base membrane or a porous membrane insufficiently treated by the electron beam to make it hydrophilic will remain opaque when the test liquid is applied to it or the membrane may slowly, greater than about 5 seconds to about 15 seconds, begin to wet the portion of the porous membrane with the liquid applied to it.

The wetting property of the membrane can be determined by applying test liquids of various surface tension to the membrane. In general, and without wishing to be bound to any particular theory, a surface having increased surface energy can be contact wet by a higher surface tension fluid. Similarly, a low surface tension fluid tends to wet a membrane better than a higher surface tension fluid. Water is a relatively high surface tension fluid, and methanol (MeOH) is a comparatively lower surface tension fluid. The surface tension of water can be modified by adding different amounts of a miscible organic liquid such as methanol to water. The surface tension in dynes/cm for various aqueous methanol and water solutions can be found in Lange's Handbook of Chemistry, 11^{th} Ed. A lower content of MeOH in a methanol in water solution necessary to wet a membrane indicates a higher surface energy membrane and indicates a membrane with improved dewetting properties, as described below. In some embodiments, the porous polymeric membrane treated by the electron beam has improved contact wettability compared to the un-treated porous membrane, which may be determined by the wettability of the surfaces with various solutions of MeOH in water.

The electron beam modified porous membranes have a surface structure and chemistry that make it contact wettable with a solution of higher surface tension than the untreated membrane. The porous membranes treated by the methods disclosed herein can be contact wettable with a MeOH in water solution containing less MeOH than a solution that can contact wet the untreated porous membrane. For example, the unmodified porous membrane can be contact wettable with a solution of 97 wt % of MeOH in water, whereas some versions the method forms an electron beam treated porous membrane that can be contact wettable with a solution of 96 wt % MeOH in water solution; in other versions, the modified porous membrane is contact wettable with a solution of 95 wt % or less of MeOH in water; in other versions, the electron beam treated porous membrane can be contact wettable with a solution of 90 wt % or less of MeOH in water; in other versions, the electron beam treated porous membrane can be contact wettable with a solution of 87 wt % or less of MeOH in water.

The electron beam modified porous membrane has a surface structure such that the minimum amount of methanol-in-water solution necessary to contact wet the treated porous membrane is at least 1 wt % less than the minimum amount of methanol-in-water solution necessary to contact wet an untreated sample of (non-electron beam treated) porous membrane.

The contact wettability of the electron beam treated membranes is stable after ambient storage as a dry membrane at room temperature in air for at least 10 days; in some versions the membrane is stable after ambient storage for at least 30 days; and in other versions the membrane is stable after ambient storage for 70 days or more. Stable contact wettability and extended shelf life following storage of the electron beam treated membrane is beneficial for maintaining consistent flow properties in gas generating liquids after long term storage or use of the filters.

Versions of the invention can include polymeric porous membrane compositions and method for making them that comprise one or more electron beam modified surfaces on the membrane.

### Membrane Resistance to Dewetting

The electron beam modified polymeric porous membrane surfaces that have improved contact wettability also have improved resistance to dewetting. In some versions of the invention the interaction of the electron beam with the porous membrane is continued until the contact wettability of the treated membrane is increased such that the treated porous membrane resists dewetting or becomes non-dewetting. Whereas contact wettability refers to the ability to wet a dry membrane at the outset, dewetting refers to the process whereby a wet membrane becomes dry or no longer wet. This can occur due to prolonged exposure to air or other conditions designed to promote dewetting. It can also occur due to outgassing by using the membrane to filter a gas-containing liquid; the gas displaces sufficient liquid from the pores of the membrane to increase the opacity, increase the pressure drop, or increase flow time. An increase in any of these properties greater than 25% is considered a dewet membrane. Non-dewetting refers to modified porous membranes compositions that remains wet with liquid after contacting or filtering a gas containing liquid.

Resistance to dewetting can be determined by weight change of a wet membrane sample compared to its dry weight. During use in a filtration process, the filter can be exposed to air under small pressure differentials across the filter such as during a replacement of the liquid being filtered.

The non-dewetting properties of electron beam treated porous membranes of the present invention can be determined by heating a membrane sample wet with a liquid, for example water, in an autoclave above the boiling point of the liquid. During the autoclave process gas dissolved in the water comes out of solution because the solubility of the gas decreases in the autoclave, and the gas can displace water in an untreated membrane. This is an example of a gas containing liquid contacting the membrane.

The determination of whether a membrane is wet can be made by visual inspection. An unwet (or dewet) membrane has an opaque appearance. Upon wetting the membrane by contacting it with a low surface tension fluid, such as isopropyl alcohol, the membrane becomes translucent. Dewetting can be observed when a wetted membrane develops spots that are opaque and no longer translucent. In some instances, the entire membrane becomes opaque and is substantially or completely dewetted. Thus, a membrane that resists dewetting resists the development of spots or locations of opaque character. An untreated membrane will become opaque and cloudy after treatment in the autoclave. A membrane that resists dewetting remains more translucent.

If a porous membrane sample is non-dewetting, the sample will remain wet and translucent following the autoclave treatment. If a wet base membrane or a wet electron beam membrane insufficiently treated to make it more hydrophilic is subject to the same autoclave treatment, it will de-wet and appear opaque following autoclave treatment. In another illustrative example, an electron beam treated fluorocarbon porous membrane wet with water is non-dewetting if following autoclave treatment at a temperature of 135° C. in water for 40 minutes the porous membrane remains translucent. Non-dewetting differs from contact angle measurements of a film's surface energy in that non-dewetting refers to the wetting property of the membrane throughout the membrane's thickness rather than just an outer surface of the membrane.

In some versions of the invention, the method results in a treated membrane that resists dewetting more than the untreated membrane. In other versions of the method, the treated membrane is substantially non-dewetting. In other versions of the method, the treated membrane is completely non-dewetting. In some versions of the invention, the electron beam treated porous membrane resists dewetting after autoclave treatment at a temperature of 135° C. in water for 40 minutes. In some versions of the invention, the electron beam treated porous membrane is non-dewetting after autoclave treatment at a temperature of 135° C. in water for 40 minutes.

### Membrane Mechanical and Filtration Properties

The electron beam treated membranes with improved wettability prepared by the methods described herein retain their filtration properties while having decreased tensile strength. The strength or average strength of the membrane is not reduced by more than 75% of the strength of the untreated porous membrane. Membranes modified in accordance with this invention can have the particle retention properties of unmodified membranes while substantially maintaining the flux characteristics of the unmodified substrate.

Porous membranes can be characterized by nominal pore size, which is directly related to the membrane's particle retention characteristics. In some versions the porous membrane is a sieving filter that removes particles by a sieving mechanism. Pore size is proportional to the size of the particle retained by sieving filtration, and pore size can be related to flow rate through the membrane. It is desirable to maximize both particle retention and flow rate. Significantly increasing one of these characteristics while significantly reducing the other of these characteristics is undesirable and can be avoided in versions of the present invention which omit the use of solution based coatings to modify the membrane. In one version of this invention, a surface modified porous membrane is formed having an average pore size of 0.05 micron or less.

A comparison of the scanning electron microscope (SEM) of the starting and electron beam treated membrane show no apparent change in appearance. It is expected that the sieving particle retention properties of the membrane do not change or are within about ±25% or less, ±15% or less, and in some versions ±10% or less of the sieving particle retention of the untreated membrane. It is expected that the particle shedding of the treated membrane will be similar to the base membrane based on this analysis. The electron beam modified porous membrane in versions of the invention can be a microporous membrane that can have a sieving log retention value (LRV=−log [1−(retention %)/100] of at least 3 for 0.1 micron or smaller particles in a liquid; can have a sieving LRV of at least 3 for 0.05 micron or smaller particles in a liquid; and can have a sieving LRV of at least 3 for 0.03 micron or smaller particles in a liquid.

The particle retention properties of the electron beam treated porous membranes can be compared to the porous membrane substrate having an unmodified surface as measured by a modified SEMATECH particle retention method described in Millipore Corporation Technical Document MA041, available from Millipore Corporation, Bedford, Mass., USA and which is incorporated herein by reference. In some versions of the invention it is expected that the particle retention properties of the treated membrane will be substantially the same, within about ±25% or less, than the unmodified membrane.

In addition, the electron beam treated porous membrane composition does not promote the nucleation of gases on the surfaces of the membrane when in contact with or during filtration of an outgassing liquid; these membranes can be characterized as non-dewetting. Thus, when filtering an outgassing liquid such as but not limited to an SC1 or SC2 cleaning baths for wafers used in microelectronics manufacturing, the effective life of the membrane of this invention is significantly greater than the effective life of unmodified porous membranes.

A flow time for a porous membrane sample can be determined by wetting a sample of membrane with a low surface tension liquid, and then flushing the membrane to remove residual wetting liquid. At a fixed pressure inlet to the membrane and a known volume of liquid, the time it takes to flow the liquid (which can be temperature corrected for viscosity) through an area of the membrane can be measured. For tight membranes the flow time is longer than for more open membranes. For example, one can measure the time to flow about 100 ml of water under a pressure of about 10 psi to about 15 psi through an isopropyl alcohol (IPA) wet and water flushed porous membrane having an area of about 20 cm². This test can be performed on control (untreated) membranes, electron beam treated membranes, and autoclave treated membranes. The test can use purified water as the liquid. This helps to exclude other potential flow rate reducing effects due to viscosity differences in the liquid or due to increased resistance to flow caused by particulates removed from the liquid which can become trapped on the membrane surfaces. Flow times before and after the autoclave treatment may be performed to determine the change in flow time after autoclaving. An increase in flow time for purified water of greater than 25% after autoclave treatment can be used to characterize a dewetting membrane.

A bubble point pressure test can also characterize the degree of dewetting observed in a membrane. The bubble point pressure test method measures the pressure necessary to force air through the pores of a membrane which were previously wet with a liquid. The liquid can be water, isopropyl alcohol (IPA), methanol, ethanol, or any other suitable liquid. Generally the lower the bubble point pressure of a membrane, the higher the potential for dewetting upon exposure to air. The bubble point pressure of the electron beam treated porous membranes of the present invention are greater than the bubble point pressure of insufficiently modified or control porous membrane substrates.

The pressure drop of a filter is a measure of the resistance of the filter to liquid flow. A high pressure drop indicates a high liquid flow resistance, such as when the filter is dewet or is plugged by a gas or particles in the membrane pores. A low pressure drop indicates a low liquid flow resistance, such as when the filter is new and completely wet. In most cases, pressure drop data should be considered relative to the same filter before and after electron beam treatment. Pressure drops can be measured in pounds per square inch (psi) or Pascals of differential pressure across the filter normalized at a constant liquid-flow rate of 1.0 U.S. gallon per minute (gpm) or 3.78 liters per minute (lpm). During testing, pressure drop is most preferably measured with purified water on a pre-wet and flushed filter.

For example, the electron beam modified porous membrane of this invention can have substantially the same permeability as measured by pressure drop as the unmodified porous membrane substrate. That is, this pressure drop does not vary by more than ±25% as compared to the pressure drop across the unmodified porous membrane substrate with the modified porous membrane of this invention. In some versions of the electron beam treated porous membrane, this pressure drop variation does not exceed ±15% and, in some versions, the variation does not exceed ±10% as compared to the pressure drop across the unmodified porous membrane substrate. Without wishing to be bound by any particular theory, it is believed that the pressure drop does not change substantially because the membrane pores are not obstructed by the deposition of matter at the pore. In other words, the present method does not result in the grafting or deposition of polymerizable monomers that build-up on the membrane surface or create a new surface layer that would otherwise obstruct flow through the membrane pores.

### Membrane Chemical Characteristics

Without being bound to any particular theory, changes in the surface atoms and functional groups of a membrane affect the membrane's contact wettability and resistance to dewetting. In some embodiments, surface polymer groups on one or more surfaces of the porous membrane are replaced with other functional groups during the electron beam treatment. Without being bound to any particular theory, exposure of a surface to high-energy electrons can result in the ejection of a binding or nonbinding electron and the generation of a radical (otherwise known as an unpaired electron). This unpaired electron is reactive and can react with the chemical solution that the membrane contacts during electron beam treatment. For example, the chemical solution may be an aqueous solution that having dissolved sulfur compounds, such as sulfates or sulfites. Some of the existing polymer bonds (e.g., carbon-fluorine bonds) are broken and the surface structure is modified to include, for example, carbon-oxygen or carbon-sulfur bonds, where the oxygen and sulfur were initially dissolved in the chemical solution. The nature of the functional group transferred to the membrane depends on the nature of the chemical solution and can include, but is not limited to, carbonyl, carboxyl, ether, thioether, hydroxyl, acyl fluoride, sulfate, sulfite groups or other hydrophilic groups, such as amine functional groups. These groups can be represented chemically as —C═O, —COOH, —C—O—C—, —C—S—C—, —C—OH, —C(F)═O, —SO₃H, —SO₂H, and NR₂. These functional groups modify the chemical structure of the membrane surfaces, and the result is the insertion of a polar functional group on the surfaces of the porous membrane that can hydrogen bond. By increasing the surface energy of the membrane surfaces, the membrane becomes more hydrophilic.

The surfaces of the electron beam modified membranes in versions of the invention resist dewetting because the surfaces are more hydrophilic and less hydrophobic. A more hydrophilic membrane is characterized by a decrease in the amount of MeOH in water necessary to contact wet the membrane or by increased resistance to dewetting, as described above. The hydrophilic surface can be formed on one or more of the fluid contacting surfaces of the porous membrane by the electron beam treatment.

The atomic composition of the membrane surfaces can be analyzed by X-ray photoelectron spectroscopy (XPS). In some versions of the method of the invention, the electron beam modified membrane has different chemical composition than the untreated membrane. In some versions of the method, the electron beam treated membrane has an oxygen-to-carbon ratio (O/C) that is different from the untreated membrane. For example, the O/C ratio of the electron source modified membrane can be greater than the O/C ratio of the untreated membrane. For example, the O/C ratio of the treated membrane can be between about 0.01 and about 0.02. In other versions of the invention, the O/C ratio can be between about 0.012 and about 0.015. In some versions of the method, the electron beam treated membrane has a halogen-to-carbon ratio, for example a fluorine-to-carbon ratio (F/C), that is different from the untreated membrane. In some versions of the invention, the F/C ratio of the treated membrane can be about zero to 5% lower than the F/C ratio of the untreated membrane. In still other versions of the invention, the F/C ratio of the treated membrane can be approximately 5% lower than the F/C ratio of the untreated membrane.

The extractable content of the modified porous membrane can be determined by soaking a portion of the membrane in an acid solution of HCl or nitric acid for one or more days and analyzing the acid solution by inductively coupled plasma mass spectrometry (ICP-MS) or other suitable technique. The extraction solution can be 10% v/v of 37% HCl in deionized water. The electron beam treated microporous membrane having one or more regions or layers can have less than 200 parts per billion total for extractable ions, for example by a 10% HCl overnight extraction, including calcium and sodium.

### Electron Beam Modification of Membranes

Versions of the invention include a method of treating a halocarbon membrane, particularly a fluorocarbon membrane, to modify the contact wettability of one or more surfaces thereof. The method can include the steps of contacting the membrane with a chemical solution while exposing the membrane to an electron source for a period of time sufficient to modify the contact wettability of one or more surfaces of the membrane.

The method can also include the step of prewetting the membrane with a low surface tension fluid prior to contacting the membrane with a chemical solution. In some instances, the low surface tension fluid can be isopropyl alcohol.

The method can also include the step of contacting the membrane with an acid after exposing the membrane to an electron source. The acid can extract residual metal ions remaining on the membrane after treatment. The method can also include the step of contacting the membrane with a rinsing fluid after exposing the membrane to an electron source. The method can also include the step of drying the membrane after exposing it to an electron source.

In some instances, the membrane is a fluorocarbon membrane and can be a PTFE membrane. In some instances, the membrane can be a single layer. In some instances, the membrane can include a plurality of layers.

In some instances, the chemical solution that contacts the membrane while it is exposed to an electron source can be purified water. In some instances, the chemical solution can also include Na₂SO₃. In some instances, the chemical solution can also include Na₂SO₄. In some instances, the chemical solution can also include sodium vinyl sulfonate. In some instances, the chemical solution can also include potassium hydroxide (KOH) or sodium hydroxide (NaOH). Without wishing to be bound to any particular theory, these additives can improve the electron beam treatment by replacing the halogen atoms in the membrane backbone with other functional groups, thereby making the membrane more hydrophilic.

In some instances, the chemical solution can also include a photoinitiator. In some instances, the photoinitiator can be IRGACURE® 2959 (BASF, Ludwigshafen, Germany) or a substantially similar product sold under any other trade name. IRGACURE® 2959 is the trade name for a chemical having the formula 1-[4-(2-Hydroxyethoxy)-phenyl]-2-hydroxy-2-methyl-1-propane-1-one. Other photoinitiators can be used, particularly water-soluble photoinitiators.

In some instances, the chemical solution can include a surfactant. A surfactant can be a cationic surfactant, an anionic surfactant, a nonionic surfactant, or an amphoteric surfactant. Ionic surfactants typically include a counterion. Preferably, the surfactant and its counterion are soluble in water. A surfactant and counterion soluble in an organic solvent can also be used. In some instances, the surfactant is an anionic surfactant and a metal counterion. An anionic surfactant is typically an anionic moiety covalently bonded to a straight or branched saturated, unsaturated, or aromatic hydrocarbon chain. The anionic moiety of the surfactant can include a sulfate, sulfite, nitrate, nitrite, or phosphate group or groups. The cationic species can be a metal ion. Typically, the cationic species readily adopts a +1 or a +2 oxidation state. Common examples include lithium, sodium, potassium, beryllium, magnesium, calcium, cobalt, nickel, copper, zinc, or any other acceptable metal. Preferably, the cationic counterion is soluble with the chemical species. In some instances, the surfactant can be sodium dodecyl sulfate.

In some instances, the chemical solution can include one or more additives selected from Na₂SO₃, Na₂SO₄, sodium vinyl sulfonate, IRGACURE® 2959, and sodium dodecyl sulfate, and combinations of these.

In some instances, the electron source can be an electron beam. In some instances, the electron beam can be operated at a voltage between about 50 kV to about 175 kV. More preferably, the electron beam can be operated at a voltage between about 140 kV and about 175 kV. In some instances, the membrane can be exposed to a radiation dosage between about 1 MRad to about 10 MRad. More preferably, the membrane can be exposed to a radiation dosage between about 3 MRad to about 8 MRad.

There are a variety of operating voltages and dosage regimes to which the membrane can be exposed. One of ordinary skill in the art will recognize that there is a relationship between operating voltage, radiation dosage, line speed, and the chemical and physical modifications to the membrane. Increasing the voltage can modify the membrane surface more quickly, thus resulting in an increased radiation absorbed dosage (Rad). High operating voltages and high radiation absorption dosages can also result in delamination of the membrane or other undesirable physical deformation of the membrane structure. Therefore, at higher voltages, it may be desirable to increase the line speed, thereby decreasing the duration of time that the membrane is exposed to the electron beam, decreasing the radiation dosage, and decreasing the likelihood of membrane delamination. Likewise, at lower operating voltages, it may be necessary to decrease the line speed or treat the membrane more than once. Furthermore, one of skill in the art will recognize that different chemical solutions will be more or less effective at treating the membrane under the different electron beam operating regimes.

In some instances, the acid that contacts the membrane after electron source treatment can be H₂SO₄. In other instances, the acid can be nitric acid In some instances, the rinsing fluid that contacts the membrane after electron source treatment can be purified water or deionized water.

In some instances, the treated membrane is contact wettable with a solution containing less MeOH in water than the untreated membrane. In some instances, the treated membrane resists dewetting more than the untreated membrane. In some instances, the treated membrane is substantially non-dewetting. In some instances, the treated membrane is completely non-dewetting. In some instances, the treated membrane has essentially the same porosity as the untreated membrane. In some instances, treatment of a membrane comprising a plurality of layers does not result in substantial delamination or separation of the layers.

Versions of the invention include an electron source modified membrane comprising a halogen-to-carbon mole ratio that is about 5% lower than the untreated membrane, for example a fluorine-to-carbon mole ratio that is about 5% lower than the untreated membrane, and a sulfur-to-carbon ratio that ranges from 0 to about 0.006, wherein the electron beam surface modified membrane has essentially the same porosity as the untreated membrane, and wherein the flow time of the electron beam surface modified membrane does not increase by more than about 30% compared to the untreated membrane.

Electron beam treatment modifies the surface energy of one or more of the porous membrane surfaces. These surfaces can include the outer handling surfaces as well as inner pore surfaces. The polymeric porous membrane can have a portion of one or more fluid contacting surfaces electron beam treated, or the porous membrane can have all of its fluid contacting surfaces completely electron beam modified. Both sides of the porous membrane can be treated using one or more passages through the treatment cavity. The higher the density of surface groups formed on the porous membrane surfaces, the greater the wettability and the more resistant the porous membrane is to dewetting when filtering a gas containing liquid, a gas generating liquid or other similar fluid.

The method described herein differs from a deposition process where a thin coating is formed on the surface of the membrane by a chemical or plasma treatment. This process also differs from a grafting method whereby the surface is first exposed to an electron beam, and then in a second step is contacted with a grafting solution.

The porous membrane can be treated in a static (batch) mode, a continuous process, or a combination of these. The electron beam treatment can occur in a single exposure, a continuous exposure process on a web or film of a porous membrane, or it can include one or more passes through the electron beam. In some versions of a continuous treatment process, the rate of passage of the porous membrane through the electron beam can range from about 1 foot per minute to about 50 feet per minute (FPM), or more preferably from about 10 FPM to about 20 FPM. In some versions of the method, the number of passes of the membrane or partially modified version of the membrane through the electron beam can range from about 1 pass to about 10 passes, or more preferably from about 1 pass to about 5 passes, or more preferably from about 1 pass to about 2 passes. In some versions of the method, the membrane is exposed to a radiation dosage, measured as radiation absorbed dosage (Rad), of about 1 MRad to about 10 MRad, or more preferably from about 3 MRad to about 8 MRad. 1 MRad=1 mega-Rad=1,000,000 Rad.

Purified water can be deioinzed or distilled water. In some cases the purified water can be water having a total organic content (TOC) in the range of from about 6 parts per billion to about 2 parts per billion or less, a resistivity of about 17.7 megaohms-cm to about 18.2 megaohms-cm or more, and average particle counts of less than about 800 counts/liter for about 0.05 micron sized particles.

The electron beam treated porous membrane surfaces can be made free of ionic and or organic extractables which may be present in a solution of a coating material that is applied to a porous membrane to make it hydrophilic. This can minimize extractables, for example trace amounts of ionic and organic materials that can corrupt a fluid being filtered. In some embodiments the electron beam modified membrane has less than about 200 ppb total for extractable ions such as sodium, calcium, zinc, iron, copper, potassium, and aluminum. In some embodiments the electron beam modified membrane has less than about 20 ppb total for extractable ions such as sodium, calcium, zinc, iron, copper, potassium, and aluminum. In some versions the electron beam modified membranes have less than about 20 ppb of TOCs.

One of ordinary skill in the art will recognize that the above steps can be combined or modified in multiple different ways, and that the treatment can occur at a combination of electron beam voltage, radiation dosage (MRad), treatment duration, number of treatments, feed rate of the membrane through the electron beam (line speed), surrounding environment (e.g., nitrogen gas or air), and contacting solution composition. The method and operating parameters can be varied to result in a membrane surface with a chemical and physical structure that provides the desired degree and combination of properties such as, but not limited to, contact wettability, stable wettability, resistance to dewetting/non-dewettability, retention of mechanical strength and filtration properties of the untreated membrane, non-delamination of membrane layers, low quantities of extractables, providing a decrease in particle shedding, exhibiting a substantial change in pressure drop, or combination of these properties.

Membrane Applications

Electron beam treated membranes of the present invention are integral and free of pinhole defects. They can be used as a flat sheet media, they retain sufficient strength for pleating, they can be used to form pinhole-free pleated membrane packs, and they retain sufficient strength to be bonded to other supports. For example, the electron beam treated membrane has sufficient strength and integrity that it can be pleated with one or more support or drainage support nets.

The electron beam treated membranes can be used in filtration devices such as stacked disk (plate and frame modules), spiral wound modules, core and cage cartridges, flat sheet, or hollow fiber modules. The electron beam treated membrane can be bonded to one or more supports, such as a core, a cage, or one or more endcaps. Portions or all of these supports, such as a core, cage, endcaps, or other fluid contacting surface may also be electron beam treated. One or more webs, nets or drainage layers can also be pleated and bonded on either side of the treated membrane. The electron beam treated membranes, drainage nets, a core, a cage, and endcaps can be bonded together to form a cartridge. In some filtration applications a filter device can be in the form of a replaceable or permanently bonded filter cartridge mounted in a housing, which has input and output ports in the process flow path. Such a filter cartridge can have a pleated membrane arranged in a cylindrical configuration.

The electron beam treated porous membrane can be used to remove impurities, exchange energy, or any combination of these from a fluid or slurry that contacts the modified membrane. Impurities can include particles, ions, proteins, or gels. In some versions the porous membrane has the retention and structural characteristics of a sieving filter in that it removes particles by a sieving mechanism as contrast to a depth media. This conditioned fluid can be used in chemical reactions or processes with other liquids, powders, or substrates.

Membranes can be configured to remove contaminants from liquid in a fluid flow circuit. The membrane may be configured in a filter cartridge and the filter used to remove particles from an SC1 or SC2 cleaning bath in a re-circulating or single pass wafer cleaning apparatus.

### EXAMPLE 1

Electron beam treatment of multilayer (support, filtration, support) 0.03 micron PTFE membrane samples obtained from Japan Gore-Tex, Inc. (Tokyo, Japan) was performed at different electron beam voltages, radiation dosages, line speeds, and numbers of treatments (i.e., passes through the electron beam). In this example, pieces of membrane were cut into coupon-sized pieces and exposed to an electron beam. The experimental conditions and results are listed Table 1. In each sample, the membrane was not contacted by a solution prior to electron beam exposure. All Samples were conducted under nitrogen gas except for Sample 4, which was conducted in air.

TABLE 1
Electron beam treatment of 0.03 μm PTFE porous membrane

| | e-beam condition | | | | | |
|---|---|---|---|---|---|---|
| | | | Line | Envi- | | |
| Sample | Voltage | Dose | speed | ron- | Times | |
| # | (kV) | (Mrad) | (FPM) | ment | treated | Results |
| 1 | 140 | 3 | 20 | N2 | 1st | not wetable in |
| | | | | | | 90% MeOH |
| 2 | 140 | 6 | 20 | N2 | 1st | not wetable in |
| | | | | | | 90% MeOH |
| 3 | 140 | 9 | 20 | N2 | 1st | not wetable in |
| | | | | | | 90% MeOH |
| 3 | 140 | 3 | 20 | N2 | 2nd | not wetable in |
| | | | | | | 90% MeOH |
| 3 | 140 | 3 | 20 | N2 | 3rd | not wetable in |
| | | | | | | 90% MeOH |
| 3 | 140 | 3 | 20 | N2 | 4th | not wetable in |
| | | | | | | 90% MeOH, |
| | | | | | | sample damaged |
| 3 | 175 | 3 | 20 | N2 | 5th | not wetable in |
| | | | | | | 90% MeOH |
| 3 | 175 | 13 | 20 | N2 | 6th | back side wetted |
| | | | | | | by 90%, not front |
| | | | | | | side, sample |
| | | | | | | damaged |
| 1 | 175 | 10 | | | 2nd | not wetable in |
| | | | | | | 90% MeOH |
| 1 | 175 | 10 | 20 | N2 | 3rd | not wetable in |
| | | | | | | 90% MeOH, |
| | | | | | | sample damaged |
| 4 | 175 | 10 | 20 | air | 1st | surface damaged, |
| | | | | | | not wettable |
| | | | | | | in 90% MeOH |

The results show that treatment of a PTFE membrane without contacting the membrane with a chemical solution did not produce a membrane that is wettable with 90% MeOH. Sample 1 was treated three times and Sample 3 was treated six times. Further treatments damaged the membrane.

### EXAMPLE 2

Electron beam treatment of multilayer (support, filtration, support) 0.03 micron PTFE membrane samples obtained from Japan Gore-Tex, Inc. (Tokyo, Japan) was performed at different electron beam voltages, radiation dosages, line speeds, and numbers of treatments (i.e., passes through the electron beam). In this example, pieces of membrane were cut into coupon-sized pieces and exposed to an electron beam. The experimental conditions and results are listed Table 2. In each sample, the membrane was contacted with a solution of IRGACURE ® 2959 and sodium vinyl sulfonate prior to electron beam exposure. In each sample, the line speed was 20 FPM and the environment was nitrogen gas.

TABLE 2
0.03 μm PTFE electron beam treated porous membrane.

| | e-beam Condition | | | | | |
|---|---|---|---|---|---|---|
| | Voltage | Dose | Times | | | MeOH |
| Sample # | (kV) | (MRad) | treated | Results | Notes | wettability |
| 1 | 175 | 10 | 1 | Some slightly surface | Membrane delaminated | 90% |
| | | | | damage, no clear | after AC, Clear with white | |
| | | | | delamination | spotes | |
| 2 | 140 | 6 | 1 | good | Clear with white spots | 90% |
| | | | | | after AC | |
| 3 | 140 | 6 | 2 | good but some | Clear with white spots | 87-90% |
| | | | | delamination | after AC | |
| 4 | 140 | 10 | 1 | good, | Clear with white spots | 90% |
| | | | | | after AC | |
| 5 | 140 | 10 | 2 | good but severe | Clear with white spots | 87% |
| | | | | delamination | after AC | |
| 6 | 155 | 10 | 1 | good, some slightly | Clear with white spots | 90% |
| | | | | surface damage, no clear | after AC | |
| | | | | delamination | | |

The contact wettability of the electron beam treated membrane (samples 1-6) is given in Table 2. Each sample showed contact wettability with a solution of 90% MeOH or less. Samples 3 and 5 showed contact wettability with an 87% MeOH solution. These results show that electron beam treatment of porous membranes can be used to form stable contact wettable porous membranes. These results also show that contacting the membrane with a chemical solution prior to exposure to the electron beam improves the contact wettability compared to exposure to an electron beam without treating the membrane with a chemical solution, as demonstrated in Example 1.

### EXAMPLE 3

Electron beam treatment of multilayer (support, filtration, support) 0.03 and 0.02 micron PTFE membrane samples obtained from Japan Gore-Tex, Inc. (Tokyo, Japan) was performed with different contact formulations. In this example, pieces of membrane were cut into coupon-sized pieces and exposed to an electron beam. In each example, the electron beam was operated at the following conditions: Voltage=140 kV; Radiation dose=6 MRad; Line speed=10 FPM; Environment=Nitrogen gas. The remaining experimental conditions and results are listed Table 3.

TABLE 3
0.03 μm and 0.02 μm PTFE electron beam treated porous membrane

| | Formulation | Sample | Times | |
|---|---|---|---|---|
| Membrane | Treatment | # | treated | Results after AC |
| JGI-0.03 | DIW | 01 | 1 | damaged, some |
| | | | | white spots |
| JGI-0.03 | DIW/SDS | 02 | 1 | white spots |
| JGI-0.03 | 2959/SDS/SVS | 03 | 1 | clear |
| JGI-0.03 | SDS/Na2SO3 | 04 | 1 | clear, delamination |
| JGI-0.02 | SDS/Na2SO3 | 05 | 1 | clear |
| JGI-0.03 | SDS/Na2SO4 | 06 | 1 | clear, pinhole at |
| | | | | edge |
| JGI-0.03 | 2959/SDS/Na2SO4 | 07 | 1 | clear, delamination |
| JGI-0.03 | SDS/DIW | | 0 | cloudy |

Sample #01 shows the results of exposure to the electron beam while the membrane contacts deionized water (DIW) only. After treatment in the autoclave (AC) the membrane was damaged and showed white spots, which are evidence of dewetting. Sample #02 shows treatment with DIW and sodium dodecyl sulfate (SDS). After treatment in the AC, the membrane did not delaminate, but it showed white spots, which are evidence of dewetting. Sample #03 shows treatment of a solution of IRGACURE® 2959, SDS, and sodium vinyl sulfonate (SVS). After treatment in the AC, the membrane did not delaminate, and the membrane remained clear. This is evidence that the membrane is non-dewetting. Samples #04 and #05 show treatment of a 0.03 and a 0.02 μm membrane in a solution of SDS and sodium sulfite (Na₂SO₃). After treatment in the autoclave, the 0.03 μm membrane delaminated while the 0.02 μm membrane did not. Sample #06 shows treatment in a solution of SDS and sodium sulfate (Na₂SO₄). After treatment in the autoclave, the membrane remained clear, but there was a pinhole at the edge. Sample #07 shows treatment in a solution of IRGACURE® 2959, SDS, and Na₂SO₄. After treatment in the autoclave, the membrane remained clear but showed some delamination. The last entry on Table 3 shows the results for a membrane that was not exposed to the electron beam. After treatment in the autoclave, the membrane became cloudy, which is evidence of dewetting. This entry serves as a control example and demonstrates that exposure to a chemical solution alone is insufficient to provide a non-dewetting membrane.

### EXAMPLE 4

This example illustrates the tensile strength and mean bubble point (MBP) properties of an electron beam treated sample. For this experiment, a 0.02 μm membrane was exposed to an electron beam. In each example, the membrane was treated while contacting a formulation of sodium dodecyl sulfate (SDS) and Na₂SO₃ in deionized water. In each example, the environment was nitrogen gas and each sample was treated once. The flow time was determined using deionized water. The exposure conditions are shown below in Table 4a.

TABLE 4a
0.02 μm PTFE electron beam treated porous membrane at varying
voltages, doses, and feet per minute for subjection to tensile strength test

| | e-beam Condition | | | | | | |
|---|---|---|---|---|---|---|---|
| | | | Line | Flow Time | | | |
| Sam- | Voltage | Dose | speed | Before | After | | MeOH |
| ple # | (kV) | (MRad) | (FPM) | AC | AC | Change | wettability |
| 2 | 160 | 4 | 10 | 322.8 | 358.5 | 11.1% | 93% |
| 4 | 160 | 8 | 10 | 309.7 | 324.9 | 4.9% | 90% |
| 5 | 150 | 6 | 15 | 310.8 | 351.5 | 13.1% | 93% |
| 6 | 160 | 8 | 10 | 316.8 | 372.9 | 17.7% | 92% |

After exposure to the electron beam, the samples were tested to determine the mechanical strength properties and the mean bubble point (MBP). The results are shown in Table 4b.

TABLE 4b
Mechanical properties of electron beam treated membranes

| | | | | Tensile | Tensile | Tensile | Tensile | | |
|---|---|---|---|---|---|---|---|---|---|
| | | | | extension | strain at | stress at | stress at | | MBP |
| | | Load at | Max | at Break | Break | Break | Max | Tensile | (HFE |
| | | Break | Load | (Standard) | (Standard) | (Standard) | Load | Stress | 7200, |
| | Sample # | (N) | (N) | (mm) | (mm/mm) | (MPa) | (MPa) | Change | psi) |
| 1 | MD | −0.37 | 27.6 | 45.21202 | 1.78 | −0.59029 | 43.5 | | |
| 2 | MD | −0.43 | 27.6 | 44.02656 | 1.73333 | −0.67294 | 43.4 | | |
| 3 | MD | −0.09 | 28.4 | 48.85265 | 1.92333 | −0.14285 | 44.7 | | |
| AVE | | | | | | | 43.9 | | |
| 4 | Xweb | 23.31 | 29.3 | 24.21453 | 0.95333 | 36.7045 | 46.1 | | |
| 5 | Xweb | 21.71 | 31.6 | 29.71765 | 1.16999 | 34.18641 | 49.7 | | 44 |
| AVE | | | | | | | 47.9 | | |
| 6 | #2 | 3.02 | 10.2 | 7.87297 | 0.30996 | 4.74876 | 16.0 | −67% | 49 |
| 7 | #4 | 0.94 | 7.6 | 8.55156 | 0.33668 | 1.4849 | 11.9 | −75% | 42 |
| 8 | #5 | 0.53 | 7.7 | 11.68406 | 0.46 | 0.827 | 12.1 | −75% | 51 |
| 9 | #6 | 2.39 | 7.7 | 5.16469 | 0.20333 | 3.75654 | 12.2 | −75% | 51 |

MD = Machine direction; control or base membrane
Xweb = cross machine direction; control or base membrane

The average tensile strength of the Samples #2, #4, #5, and #6 decreased by 67% to 75%. The mean bubble point prior to exposure to the electron beam was 44 psi. Each of the samples show a mean bubble point that did not change significantly, which is indicative of a membrane pore size that has not changed significantly during electron beam treatment.

### EXAMPLE 5

This example shows the x-ray photoelectron spectroscopy (XPS) results of Samples #3 and #5 from Example 3. Table 5 shows the chemical composition of carbon, fluorine, oxygen, and sulfur at the membrane surface.

TABLE 5
XPS results of Samples #3 and #5 from Example 3.

| Sample | | | Control | | | | | Treated | | | | | | |
|---|---|---|---|---|---|---|---|---|---|---|---|---|---|---|
| Substrate | # | Side | C | F | O | F/C | O/C | C | F | O | S | F/C | O/C | S/C |
| JGI-0.03 | 03 | side 1 | 32.4 | 67.6 | | 2.09 | 0.000 | 33.3 | 66 | 0.5 | 0.2 | 1.98 | 0.015 | 0.006 |
| | | side 2 | | | | | | 33.2 | 66.4 | 0.1 | 0.1 | 2.00 | 0.003 | 0.003 |
| JGI-0.02 | 05 | side 1 | 32.7 | 67.3 | | 2.06 | 0.000 | 33.3 | 66.3 | 0.5 | | 1.99 | 0.015 | 0.000 |
| | | side 2 | | | | | | 33 | 66.6 | 0.4 | | 2.02 | 0.012 | 0.000 |

For both Sample #03 and Sample #05, the treated membrane has a decreased fluorine content, which is evidence that carbon-fluorine bonds have been broken. For both Sample #03 and Sample #05, the treated membrane has an increased oxygen content, and for Sample #03 the treated membrane has an increased sulfur content, which is evidence that functional groups containing oxygen and sulfur are present on the membrane surface.

Although the present invention has been described in considerable detail with reference to certain preferred versions thereof, other versions are possible. Therefore the spirit and scope of the appended claims should not be limited to the description and the preferred versions contain within this specification.

1. A method of treating a microporous halocarbon membrane to modify the contact wettability of one or more surfaces thereof, the method comprising contacting the microporous halocarbon membrane with a chemical solution while exposing the membrane to an electron source for a period of time sufficient to modify the contact wettability of one or more surfaces of the membrane while retaining the chemical inertness of the membrane and without increasing the flow time by more than about 30%.

2. The method of claim 1, wherein the method further comprises the step of prewetting the membrane with a low surface tension fluid prior to contacting the membrane with a chemical solution.

3. The method of claim 1, wherein the method further comprises the step of contacting the membrane with an acid after exposing the membrane to an electron source.

4. (canceled)

5. (canceled)

6. The method of claim 1, wherein the membrane is a fluorocarbon membrane.

7. The method of claim 1, wherein the membrane is polytetrafluoroethylene.

8. (canceled)

9. The method of claim 1, wherein the membrane comprises a plurality of layers.

10. (canceled)

11. The method of claim 1, wherein the chemical solution comprises deionized water.

12. The method of claim 11, wherein the chemical solution further comprises a metal cation.

13. The method of claim 12, wherein the metal cation is sodium or potassium.

14. (canceled)

15. The method of claim 13, wherein the chemical solution further comprises Na₂SO₃, Na₂SO₄, sodium vinyl sulfonate, or sodium dodecyl sulfate.

16. (canceled)

17. (canceled)

18. The method of claim 11, wherein the chemical solution further comprises a surfactant.

19. The method of claim 18, wherein the surfactant is an anionic surfactant.

20. (canceled)

21. (canceled)

22. The method of claim 1, wherein the electron source is an electron beam.

23. (canceled)

24. The method of claim 22, wherein the voltage of the electron beam is between about 140 kV to about 175 kV.

25. (canceled)

26. The method of claim 22, wherein the radiation dosage is between about 3 MRad to about 8 MRad.

27. The method of claim 3, wherein the acid is H₂SO₄.

28. (canceled)

29. (canceled)

30. (canceled)

31. (canceled)

32. (canceled)

33. An electron source surface modified halocarbon membrane comprising a halogen-to-carbon mole ratio that is about 5% lower than the untreated membrane and a sulfur-to-carbon mole ratio that ranges from about 0 to about 0.01, wherein the electron beam surface modified membrane has essentially the same porosity as the untreated membrane, wherein the electron beam surface modified membrane is non-dewetting, and wherein the flow time of the electron beam surface modified membrane does not increase by more than about 30% compared to the untreated membrane.

34. (canceled)

35. The electron beam surface modified membrane of claim 33, wherein the electron beam surface modified membrane is a multilayered membrane that retains the integral nature of the untreated multilayer membrane.

36. The electron beam surface modified microporous membrane of claim 33, wherein the treated membrane has a sulfur-to-carbon mole ratio that ranges from about 0 to about 0.006.
